(19) United States
(12) Patent Application Publication
(10) Pub. No.: US 2026/0216778 A1
(43) Pub. Date: Jul. 30, 2026

(54) Metal Forming System

(71) Applicant: Textron Aviation Inc., Wichita, KS (US)

(72) Inventors: Darren Fair, Newton, KS (US); Wyatt Orin Smrcka, Wichita, KS (US); Mitchell Isaac Barron, Wichita, KS (US); Jacob Edward Milburn, Maize, KS (US); Stacy Wayne Hart, Wichita, KS (US)

(21) Appl. No.: 19/040,559

(22) Filed: Jan. 29, 2025

(51) Int. Cl. B21D 37/16; H05B 6/10

(52) U.S. Cl. CPC B21D 37/16; H05B 6/101

(57) ABSTRACT

A system for heating and forming metal parts. A metal part may be secured to a slidable plate configured to move the metal part into a heating coil and die. The temperature of the coil is controllable such that the metal part can be heated to a selected temperature before being moved to a selected position in the die.

### BACKGROUND OF THE INVENTION

### 1. Field

The disclosed embodiments relate generally to the field of aircraft manufacture. More specifically, embodiments relate to systems and methods for heated metal forming.

### 2. Description of the Related Art

It is known to shape metal parts by manually measuring both the temperature of the metal part and the location at which a shape will be formed into the part.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to a metal forming system including: an induction coil configured for heating a metal part positioned within the induction coil; a slidable plate configured for moving the metal part into the induction coil; a temperature sensor configured for measuring a temperature of the metal part within the induction coil; and a die operatively coupled with pneumatic cylinders configured to press the metal part into the die to shape the metal part when the slidable plate moves the metal part out of the induction coil.

In some embodiments, the techniques described herein relate to a system including a controller, wherein the controller determines a part type and a corresponding die, at least based on a part number.

In some embodiments, the techniques described herein relate to a system wherein the controller communicatively connects to the temperature sensor and controls the temperature of the induction coil.

In some embodiments, the techniques described herein relate to a system wherein the temperature sensor is a pyrometer configured to detect the temperature of the metal part positioned within the induction coil.

In some embodiments, the techniques described herein relate to a system wherein the slidable plate is configured to be driven along rods directionally aligned with the induction coil.

In some embodiments, the techniques described herein relate to a system wherein the slidable plate includes grippers configured to secure the metal part to the slidable plate.

In some embodiments, the techniques described herein relate to a system wherein the grippers include a front gripper and a back gripper configured to receive and secure the metal part to the slidable plate.

In some embodiments, the techniques described herein relate to a system including a funnel configured to align the metal part in the die and coil.

In some embodiments, the techniques described herein relate to a system including a part sensor directed towards the funnel to detect the position of the metal part relative to the induction coil and the die.

In some embodiments, the techniques described herein relate to a system wherein the funnel includes a large funnel and a small funnel, and the large funnel aligns the metal part with the small funnel and the small funnel aligns the metal part through the induction coil.

In some embodiments, the techniques described herein relate to a system wherein the large funnel and small funnel each include adjustable sidewall portions configured to adjust each funnel and align the metal part with the induction coil and die.

In some embodiments, the techniques described herein relate to a system including a locating camera configured to collect an image showing a position of the metal part in the induction coil and die.

In some embodiments, the techniques described herein relate to a method for metal forming, the method including: positioning a metal part in an induction coil using a slidable plate wherein the induction coil and slidable plate are each communicatively and operatively connected to a controller; heating the metal part using the induction coil; detecting a temperature of the metal part within the induction coil using a temperature sensing device communicatively connected to the controller; and shaping the metal part using a die to form a shaped metal part.

In some embodiments, the techniques described herein relate to a method including controlling the temperature of the metal part using the controller communicatively connected to the temperature sensing device and operatively connected to the induction coil.

In some embodiments, the techniques described herein relate to a method including aligning the metal part using a funnel prior to the step of shaping the metal part.

In some embodiments, the techniques described herein relate to a method including locating a position of the metal part using a part sensor and camera operatively and communicatively connected to the controller.

In some embodiments, the techniques described herein relate to a method wherein shaping the metal part includes forming a joggle within the metal part.

In some embodiments, the techniques described herein relate to a method wherein the metal part is a stringer such that shaping the metal part includes forming a joggle at one end of the stringer.

In some embodiments, the techniques described herein relate to a method including determining the die based on a part number input into a user interface.

In some embodiments, the techniques described herein relate to a metal forming system including an induction coil configured for heating a metal part; a die configured for shaping the metal part; a part sensor configured to detect a position of the metal part, and a temperature sensor configured to detect a temperature of the metal part wherein the part sensor and the temperature sensor are communicatively connected to a controller; and the controller configured to determine the position and the temperature of the metal part, and shape the metal part using the die.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a perspective view of the metal forming system of embodiments of the disclosure;

FIG. 2 is a another perspective view of the metal forming system of FIG. 1;

FIG. 3 is another perspective view of the metal forming system of FIG. 1;

FIG. 4 is a perspective view of a temperature sensor of the metal forming system of FIG. 1;

FIG. 5 is a perspective view of a slidable plate of the metal forming system of FIG. 1;

FIG. 6 is a perspective view of a shaped metal part formed using the metal forming system of FIG. 1;

FIG. 7 is a perspective view of funnels of the metal forming system of FIG. 1;

FIG. 8 is a block diagram of the metal forming system of FIG. 1; and

FIG. 9 is a process flow of a method carried out by the metal forming system of FIG. 1.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

### Overview

Embodiments disclosed herein provide a system and a method for automating a metal part shaping process. Previous metal forming processes and systems typically include manually placing metal parts in dies and manually measuring metal part temperatures to form metal parts. This is disadvantageous due to the lack of precision which arises from manually loading parts and measuring part temperatures; additionally, prior art methods expose operators to hazards such as heavy machinery and extreme temperatures. Embodiments disclosed herein advantageously provide automation capabilities to precisely place metal parts in dies and provide temperature sensing instruments to accurately measure metal part temperatures.

In embodiments, a system allows for the automation of a metal forming process such that metal parts may be heated and positioned in dies which allow for the metal part to be shaped with substantially more accuracy than manual methods described above. The automated metal forming system is configured with an induction coil, a slidable plate, a temperature sensor, and die to heat and form metal parts.

In embodiments, the induction coil is configured for a metal part to be positioned within the coil to be heated. In some embodiments, the induction coil is communicatively connected to a controller which controls the temperature of the coil. A temperature sensor, such as a pyrometer, may be configured to detect the temperature of the metal part within the induction coil and can be communicatively connected to the controller providing temperature control to the coil.

In embodiments, a linear motion apparatus, such as a slidable plate, is configured to move a metal part through the induction coil and into a die. The slidable plate may include funnels configured to properly align the metal part in the coil and die, and grippers to secure the metal part to the slidable plate.

In some embodiments, a die may be operatively coupled to mechanisms such as pneumatic cylinders configured to apply pressure to shape a heated metal part according to a shape of the die.

### Embodiments With Respect to Figures

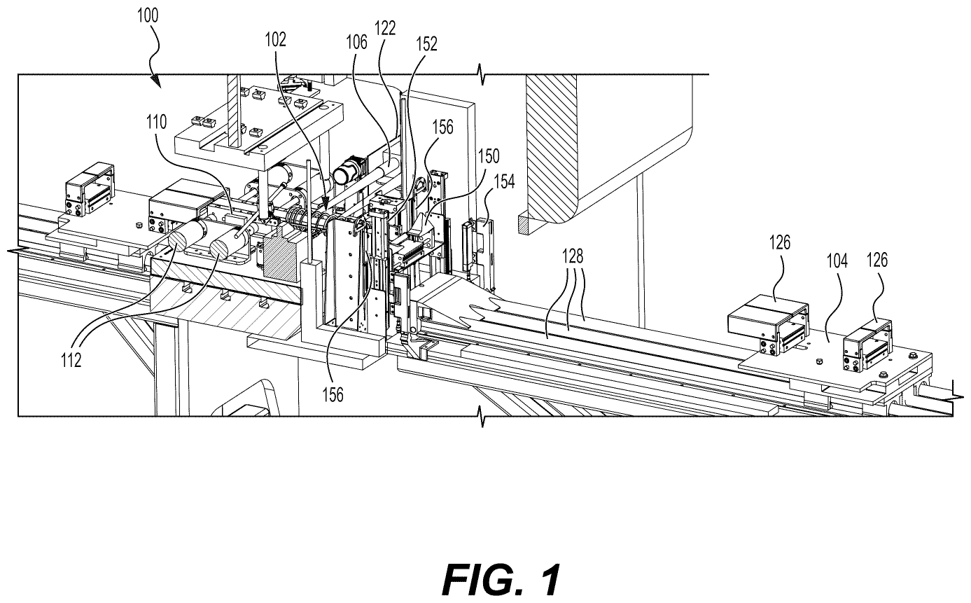

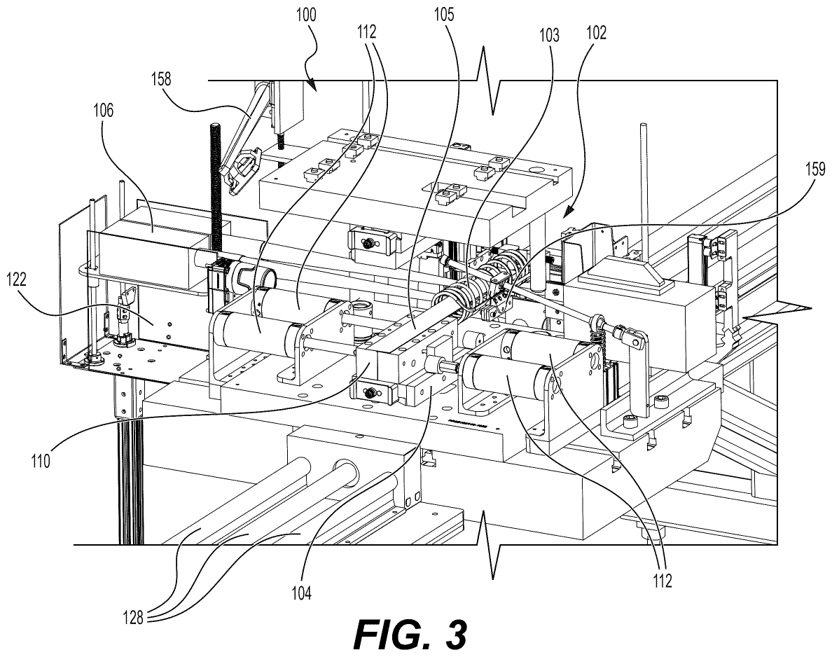

With reference to FIGS. 1-9 and the following description, a metal forming system 100 is shown and described. With reference to FIG. 1, the metal forming system 100 includes an induction coil 102, a slidable plate 104, a temperature sensor 106, and a die 110. The induction coil 102 includes a plurality of windings 103 configured for heating an object within the center of the coil in between the windings 103 of the coil 102. The slidable plate 104 is configured to be actuated to move the metal part 105 in between the windings 103 of coil 102 and can include mechanisms which secure the metal part 105 to the slidable plate 104 and position the metal part 105 within the induction coil 102 and die 110. Temperature sensor 106 is configured to detect the temperature of the metal part 105 positioned within the induction coil 102 such that the heating of the metal part 105 can be substantially controlled. After heating, the slidable plate 104 can move metal part 105 out of the induction coil 102 such that a die 110 operatively coupled to pneumatic cylinders 112 is able to press the metal part 105 into the die 110 and shape the metal part 105.

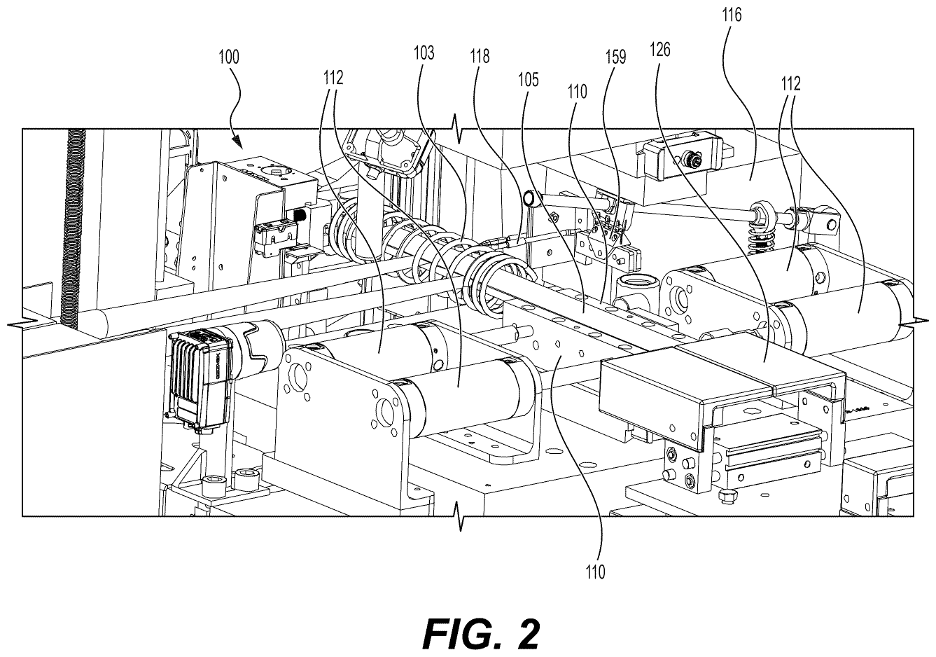

In some embodiments, the induction coil 102 can be formed from an inductive material such as copper which can be advantageous for heating. With reference to FIG. 2, the induction coil 102 can be physically and operatively connected to a heating module 116 which can increase the temperature of induction coil 102. In some embodiments, an A/C current can be directed to the induction coil 102 from the heating module 116 through voltage wires 118 which can cause the temperature of the induction coil 102 to increase. In embodiments, both ends of the coil 102 may be connected to voltage wires 118 and supplied with current and in other embodiments, one end or the other may be connected to a voltage wire 118 to receive current. Advantageously, the windings 103 of coil 102 allow metal part 105 to be heated uniformly since heat is applied through a current travelling throughout the windings 103 wrapping around the metal part 105. The temperature of the induction coil 102 can be detected by the temperature sensor 106.

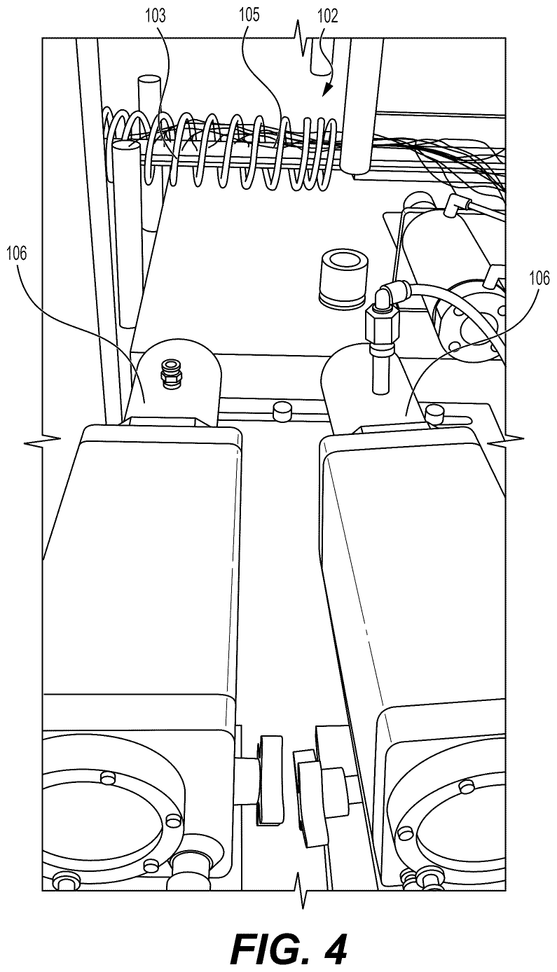

In embodiments, the temperature sensor 106 is an infrared pyrometer which detects the temperature of the metal part 105 within the induction coil 102. In other embodiments the temperature sensor 106 can be another type of temperature sensing instrument. The position of the temperature sensor 106 can be adjusted using temperature sensor motion device 122. In embodiments, the temperature sensor motion device 122 is a stepper motor driven by a screw. The temperature sensor motion device 122 allows for the temperature sensor 106 to be aligned and directed towards the center of the metal part 105. In embodiments, the temperature sensor motion device 122 can move the temperature sensor 106 upwards, downwards, leftwards, and rightwards to align the temperature sensor 106 with metal part 105. With reference to FIG. 4, the temperature sensor 106 (i.e. pyrometer) is directed towards the center of the metal part 105 in between the windings 103 of coil 102. In some embodiments, a red laser can be built into the pyrometers and used as an aiming guide to direct the pyrometers towards the metal part 105.

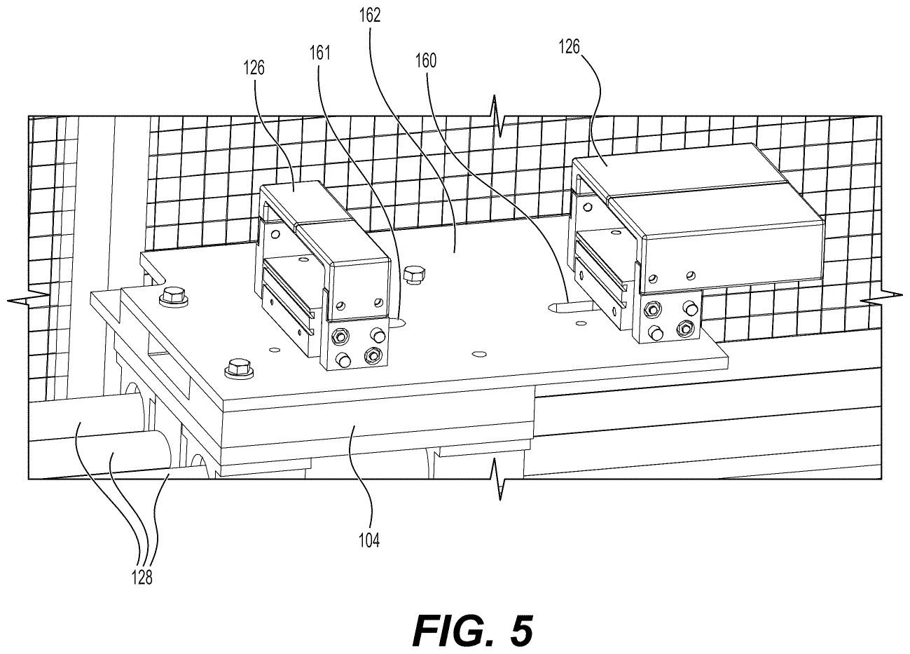

In embodiments, and with reference to FIGS. 1 and 5, the slidable plate 104 may be a press slide configured to be driven by a plate motor 124 (not physically shown). In embodiments, the plate motor 124 may be a servo motor attached to rods 128. The slidable plate 104 is configured to be driven linearly and move the metal part 105 into the coil 102 and the die 110. In embodiments, the slidable plate 104 is configured to move along linear rods 128 which are aligned with the coil 102 and span lengthwise and beneath components of the metal forming system 100. In this way, the slidable plate 104 can slide along the rods 128 to position the metal part 105 in the coil 102, for heating, and the die 110 to shape the metal part 105.

In embodiments, with reference to FIG. 5, the slidable plate 104 can include grippers 126 configured to fix the metal part 105 to the slidable plate 104 while it is driven along the rods 128 by the plate motor 124. The grippers 126 can be arranged with a front gripper and a back gripper configured to secure opposing ends or portions of the part 105. Each of grippers 126 opens and closes using pneumatic cylinders which allow for the grippers 126 to firmly hold onto the part 105. The grippers 126 can be fixed to the slidable plate 104 on a platform 162 configured as part of the slidable plate 104. The grippers 126 and slidable plate 104 are configured to be driven forward and backwards on the rods 128 by a screw mounted through the center of the slidable plate 104. When the slidable plate 104 is driven along the screw by the servo motor, the metal part 105 fixed within the grippers 126 can be positioned in and out of the coil 102 and die 110. In embodiments, slots 160 and 161 are formed into the platform 162 and may allow each of grippers 126 to be manually adjusted in relation to the part 105. For instance, the slots 160 and 161 can allow each gripper 126 to be moved forward and backward to be secured to metal part 105 which can allow for the accommodation of a wide variety of part sizes and shapes.

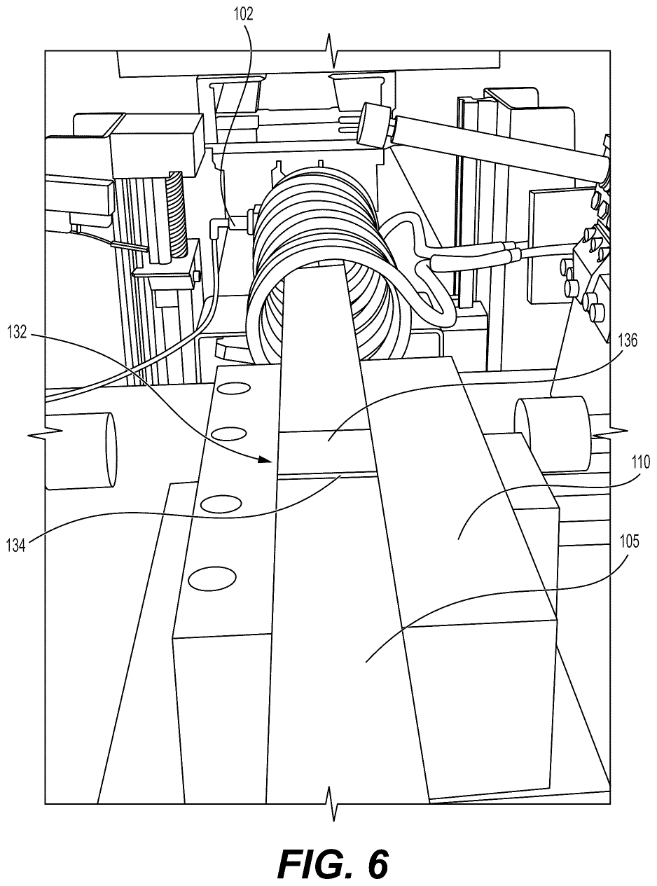

The die 110, in embodiments, is coupled with pneumatic cylinders 112 which impart pressure to the die 110 shaping the metal part 105 according to the die 110. In embodiments, different types of dies 110 may correspond to different shapes formed into metal parts 105. In some embodiments, when pressure is applied from pneumatic cylinders 112 to the die 110, the metal part 105 is shaped to form a joggle 132 (see FIG. 6). A joggle 132 is a metal part shape which can be formed into a metal part such as a stringer. A joggle 132 is a portion of a metal part shaped by die 110 and includes a bent portion 134 and offset portion 136. The bent portion 134 and offset portion 136 of the joggle 132 can be formed into an end or a middle portion of the metal part 105 and create an offset between the joggle 132 and the rest of the metal part 105. The offset of the joggle 132 can allow for the metal part 105 to overlap other metal parts and components such that the overlapped metal parts fit into the offset of the formed joggle 132. In other embodiments, the joggle 132 can be formed into other locations of the metal part 105, such as its ends or other portions along the length of part 105. In some embodiments, different types of dies 110 can correspond to different metal parts 105 and different types of shapes. In some embodiments, metal part 105 can be a stringer and in other embodiments, metal part 105 can be a longeron, girder, rail or other type of metal part. In other embodiments, the metal part 105 may be any part with a flat surface or an extrusion.

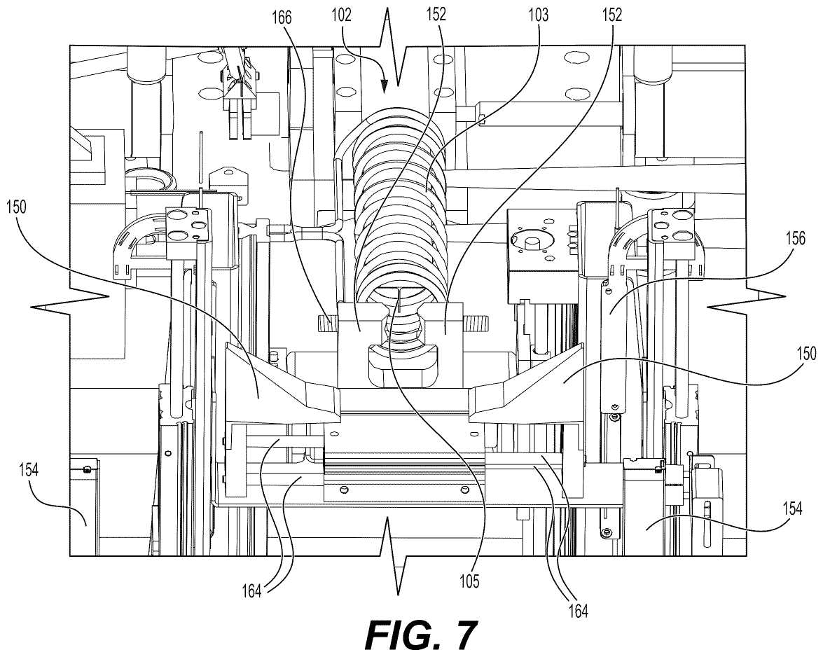

In some embodiments, with reference to FIG. 7, a large part funnel 150 and a small part funnel 152 can align the metal part 105 in the coil 102 and die 110. In embodiments, the small funnel 152 is positioned immediately in front of coil 102 and large funnel is positioned immediately behind small funnel 152 such that the small funnel 152 is in between the large funnel 150 and coil 102. Each of funnels 150 and 152 are configured with adjustable side portions which substantially align the metal part 105 into the coil 102 and die 110. In embodiments, the large funnel 150 can receive the metal part 105 and align the part with small funnel 152. The small funnel 152 can align the part to extend through the coil 102 and be accurately positioned in die 110. In embodiments, large funnel 150 allows for large tolerances of positioning and the small funnel 152 allows for small positioning tolerances and can fine tune the position of the metal part 105 in coil 102 and die 110. In embodiments, the large funnel 150 is pneumatically driven and the small funnel 152 is servo actuated on a screw to allow for fine tuning of the parts to ensure they are centered on the coil 102 (i.e. centering on the coil ensures the metal part 105 does not contact the coil 102). The large funnel 150 includes adjustable sides which are wedged-shaped grippers attached to pneumatic cylinders 164. When actuated the pneumatic cylinders 164 substantially raise the part 105 upwards and close the wedge-shaped grippers which form the sides of the funnel 150 to center the part 105 with the centerline of the coil 102. The small funnel 152 positioned directly behind the large funnel 150 includes a drive screw 166 which controls the adjustable side portions of the small funnel 152. When actuated the drive screw 166 allows the adjustable side portion to move upwards and contact the part 105 and hold it on center while the part 105 passes through coil 102. The horizontal and vertical adjustment provided by funnels 150 and 152 allows for the part 105 to be substantially centered in the coil 102 both horizontally and vertically.

A low accuracy part sensor 154 and a high accuracy part sensor 156, in embodiments, detect the position of the metal part 105 in the funnels 150 and 152 relative to the coil 102 and die 110. More specifically, the low accuracy part sensor 154 can detect the position of metal part 105 in the large funnel 150 and the high accuracy part sensor can detect the position of metal part 105 in the small funnel 152. In embodiments, the part sensors 154 and 156 may have a degree of accuracy of approximately 0.001 inches. In some embodiments, either or both of the part sensors 154 and 156 may be a fiber optic sensor.

In some embodiments a locating camera 158 can be positioned to monitor and collect an image or video feed of the die 110 and the portion of metal part 105 extending beyond the coil 102 and into die 110. In some embodiments, the locating camera 158 can be directed towards a camera light and backdrop 159 positioned to effectively increase the resolution and viewability of the environment detected by camera 158.

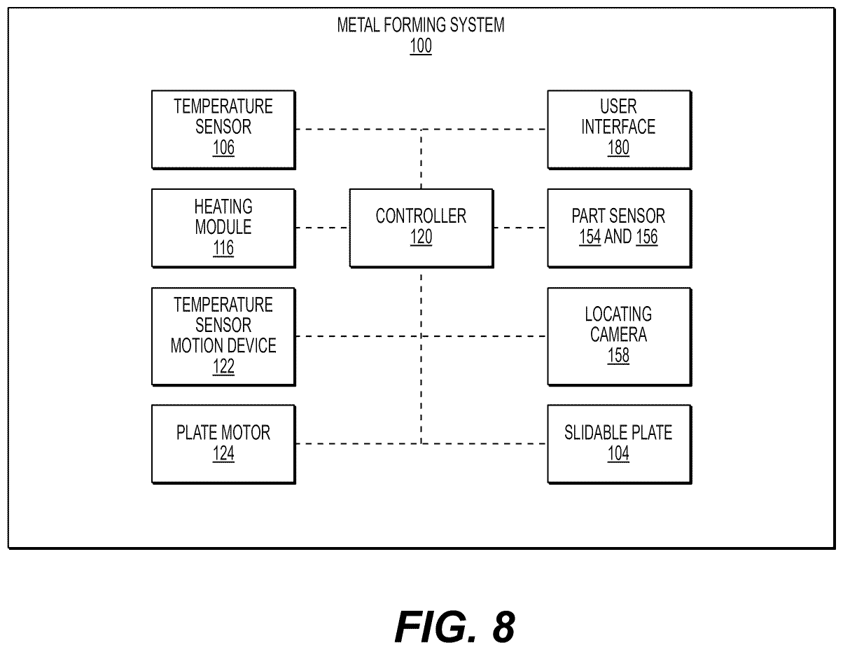

With reference to FIG. 8 the metal forming system 100 includes a controller 120 providing control for the metal forming system 100. The controller 120 is substantially able to control the metal forming system 100 such that a metal part 105 can be heated uniformly and shaped with greater precision than manually positioning and heating parts within dies. In this way, metal parts can be made faster and with an increased degree of accuracy.

The controller 120 controls the temperature of the coil 102 to uniformly heat the metal part 105 to a selected temperature which may be a temperature advantageous for metal shaping processes. The controller 120 can be communicatively connected to the induction coil 102, temperature sensor 106, and heating module 116 such that the temperature of the induction coil 102 can be adjusted to heat the metal part 105 to a selected temperature. The controller 120 may be provided the temperature of the metal part 105 by the temperature sensor 106 and can control the energy supplied to heat the induction coil 102 by the heating module 116. In this way, the controller 120 is substantially able to control the temperature of the metal part 105 being heated within the induction coil 102 by controlling the temperature of the coil 102. The controller 120 may be able to control the heating module 116 to adjust the temperature of the coil 102 in real time or near real time as the temperature sensor 106 detects the temperature of the metal part 105 positioned within the coil 102. In embodiments, the controller 120 may be able to control the temperature sensor motion device 122 to align the temperature sensor 106 with the metal part 105 in coil 102.

Sensing instruments, such as part sensors 154 and 156, and locating camera 158 are communicatively coupled with the controller 120 to give information about the position of the metal part 105 relative to the die 110. The controller 120 controls the position of the slidable plate 104 using the plate motor 124 such that the metal part 105 is aligned and positioned so that a joggle 132 or other shape can be formed into the metal part 105 at a selected position. In embodiments, the controller 120 may be able to control the plate motor 124 to move and adjust the slidable plate 104 in real or near real time such that as the part sensors 154 and 156 detect the position of metal part 105. The controller 120 can adjust the slidable plate 104 to move the metal part 105 and allow the joggle 132 to be formed into the part at a selected position.

The funnels 150 and 152 can align the metal part 105 in the coil 102 and relative to the die 110. The controller 120 may receive an image or video feed from the locating camera 158 and control the pneumatic cylinders 164 and drive screw 166 of the funnels 150 and 152 to substantially align the metal part 105 through the coil 102 and into die 110.

When the metal part 105 has been aligned and positioned to a selected location and heated to a selected temperature, the controller 120 can control the pneumatic cylinders 112 to impart pressure to the portion of the metal part within the die 110 and shape the metal part 105 according to the die 110. In this way, the controller 120 controls the metal forming of the metal forming system 100.

In some embodiments, the metal forming system 100 includes a user interface 180. The user interface 180 may be displayed on a human machine interface such as a touch screen which can be accessible by an operator or other user. The user interface 180 may require a user/operator to enter a passcode, ID badge, or other identification technique to allow a user or operator to access the user interface 180. In some embodiments, the user interface 180 can include a video feed or image detected by the locating camera 158 such that a user may monitor the heating and positioning of the metal part 105. The user interface 180 is configured to receive user inputs which may correspond to the positioning, alignment, and shape formed into the metal part 105. For instance, a user may input a part type and shape type and position such that the controller 120 can control mechanisms to properly position, heat, and shape the metal part 105.

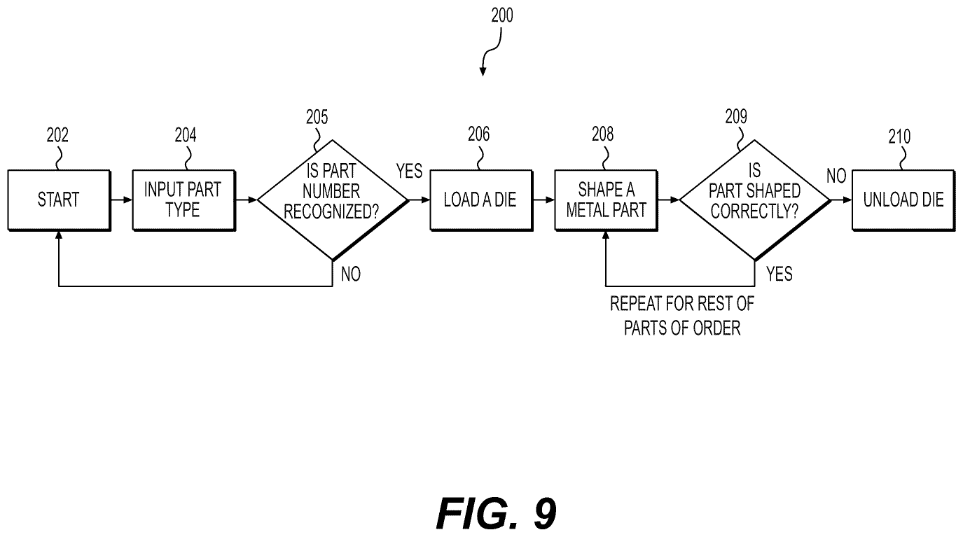

With reference to FIG. 9, a method 200 is shown which can be carried out by the metal forming system 100.

In a step 202, the method 200 begins. In some embodiments, a user can access the user interface 180 and power on the system 100.

At step 204, a part type is input to the controller 120. In embodiments, an order number and/or part number corresponding to a part type may be scanned and input into the controller 120. The user interface 180 may be used for an operator to input a part/order number, or a scanning device may be used to scan the part/order number or barcode and communicate the information to the controller 120. In some embodiments, the user interface 180 can include a display allowing for a selection of an order quantity indicating a quantity of parts to shape with the metal forming system 100.

At step 205, the controller 120 can recognize the input part type or part number. If the controller 120 does not recognize the part number or part type the process can loop back to step 202, and if the part type is recognized, the method 200 proceeds to step 206.

At step 206, a die can be loaded into the metal forming system 100. In embodiments, the controller 120 can determine the die 110 which corresponds to the input part type or part number and can load the corresponding die onto the metal forming system 100, possibly controlling mechanical arms or machines, which may be automated. In some embodiments, multiple dies 110 corresponding to different part types can be loaded into metal forming system 100. For instance, the controller 120 may determine an input part number corresponds to a die 110 being configured to shape a joggle 132 on a stringer. The controller 120 can load the corresponding die configured to form a joggle into the metal forming system 100.

At step 208, a metal part is shaped. In embodiments, the controller 120 can control the plate motor 124 to move the slidable plate 104 and move the metal part 105 through the coil 102 and into the die 110. The controller 120 can receive information from the locating camera 158 and temperature sensor 106 about the temperature and position of the metal part 105 and control the temperature of the coil 102 with heating module 116 and the position of slidable plate 104 to align the metal part 105 in the die 110.

At step 209, a user can determine if the metal part 105 is shaped correctly according to the input part type or part number. If the part 105 is shaped correctly, the operator can opt for remaining parts to be shaped and the step 208 can be repeated for the remainder of parts in the order number. If the metal part 105 is shaped incorrectly the remainder of parts remaining to be shaped will not be formed and the process proceeds to step 210.

At step 210, the die 110 can be unloaded. In embodiments, one or multiple types of dies 110 can be used and interchanged to shape the metal parts 105 to different specifications corresponding to the part type or part number.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

What is claimed:

1. A metal forming system, comprising:
an induction coil configured for heating a metal part positioned within the induction coil;
a slidable plate configured for moving the metal part into the induction coil;
a temperature sensor configured for measuring a temperature of the metal part within the induction coil; and
a die operatively coupled with pneumatic cylinders configured to press the metal part into the die to shape the metal part when the slidable plate moves the metal part out of the induction coil.

2. The system of claim 1, comprising a controller, wherein the controller determines a part type and a corresponding die, at least based on a part number.

3. The system of claim 2, wherein the controller communicatively connects to the temperature sensor and controls the temperature of the induction coil.

4. The system of claim 1, wherein the temperature sensor is a pyrometer configured to detect the temperature of the metal part positioned within the induction coil.

5. The system of claim 1, wherein the slidable plate is configured to be driven along rods directionally aligned with the induction coil.

6. The system of claim 1, wherein the slidable plate includes grippers configured to secure the metal part to the slidable plate.

7. The system of claim 6, wherein the grippers include a front gripper and a back gripper configured to receive and secure the metal part to the slidable plate.

8. The system of claim 1, comprising a funnel configured to align the metal part in the die and coil.

9. The system of claim 8, comprising a part sensor directed towards the funnel to detect the position of the metal part relative to the induction coil and the die.

10. The system of claim 9, wherein the funnel includes a large funnel and a small funnel, and the large funnel aligns the metal part with the small funnel and the small funnel aligns the metal part through the induction coil.

11. The system of claim 10, wherein the large funnel and small funnel each include adjustable sidewall portions configured to adjust each funnel and align the metal part with the induction coil and die.

12. The system of claim 1, comprising a locating camera configured to collect an image showing a position of the metal part in the induction coil and die.

13. A method for metal forming, the method comprising:
positioning a metal part in an induction coil using a slidable plate wherein the induction coil and slidable plate are each communicatively and operatively connected to a controller;
heating the metal part using the induction coil;
detecting a temperature of the metal part within the induction coil using a temperature sensing device communicatively connected to the controller; and
shaping the metal part using a die to form a shaped metal part.

14. The method of claim 13, comprising controlling the temperature of the metal part using the controller communicatively connected to the temperature sensing device and operatively connected to the induction coil.

15. The method of claim 13, comprising aligning the metal part using a funnel prior to the step of shaping the metal part.

16. The method of claim 13, comprising locating a position of the metal part using a part sensor and camera operatively and communicatively connected to the controller.

17. The method of claim 13, wherein shaping the metal part comprises forming a joggle within the metal part.

18. The method of claim 13, wherein the metal part is a stringer such that shaping the metal part comprises forming a joggle at one end of the stringer.

19. The method of claim 13, comprising determining the die based on a part number input into a user interface.

20. A metal forming system, comprising:
an induction coil configured for heating a metal part;
a die configured for shaping the metal part;
a part sensor configured to detect a position of the metal part, and
a temperature sensor configured to detect a temperature of the metal part wherein the part sensor and the temperature sensor are communicatively connected to a controller; and
the controller configured to determine the position and the temperature of the metal part, and shape the metal part using the die.
